(19) United States
(12) Patent Application Publication
(10) Pub. No.: US 2012/0188178 A1
(43) Pub. Date: Jul. 26, 2012

(54) INFORMATION PROCESSING APPARATUS AND CONTROL METHOD OF THE SAME

(75) Inventor: Yasuhiro Hamada, Kawasaki-shi (JP)

(73) Assignee: CANON KABUSHIKI KAISHA, Tokyo (JP)

(21) Appl. No.: 13/312,431

(22) Filed: Dec. 6, 2011

(30) Foreign Application Priority Data
Jan. 25, 2011 (JP) 2011-013369

(51) Int. Cl. G06F 3/041

(52) U.S. Cl. 345/173

(57) ABSTRACT

An information processing apparatus comprises: a touch panel; a touch detection unit configured to detect a touch input to the touch panel; a vibration detection unit configured to detect vibration of the information processing apparatus; and a control unit configured to execute a first function in a case where, within a predetermined period of time following detection by the touch detection unit of a single-touch operation in which the touch panel is touched and then released, touch is not detected again by the touch detection unit and, vibration that satisfies predetermined conditions is not detected by the vibration detection unit, and execute a second function when vibration that satisfies the predetermined conditions is detected by the vibration detection unit within the predetermined period of time following detection of the single-touch operation by the touch detection unit.

### BACKGROUND OF THE INVENTION

1. Field of the Invention

The present invention relates to a processing technique for detecting a touch operation onto a touch-sensitive panel.

2. Description of the Related Art

A touch-sensitive panel (touch panel) can be operated in various ways using a finger or stylus pen. Examples of these operations are an image-moving operation (a dragging operation) and a double-touch operation, which is similar to a double-click operation performed using a personal computer or the like. Since operations such as operation of a push-button switch can be performed intuitively with a touch panel, touch panels are increasingly convenient. If a single touch performed by touching the panel one time and a double touch performed by touching the panel twice in succession in a short period of time can be discriminated and a different function is assigned to each of these operations, then a user will be able to use multiple functions selectively in a simple manner.

However, it is known that it is not easy for a device to distinguish between a single touch and a double touch accurately. Accordingly, the specification of Japanese Patent Laid-Open No. 2002-323955 describes that a double touch is identified more reliably by making the threshold value of writing pressure, which is for determining that a second touch has occurred, lower than the threshold value of writing pressure for determining that a first touch has occurred. On the other hand, the specification of Japanese Patent Laid-Open No. 06-004208 describes an apparatus in which an information processing apparatus proper is equipped with an acceleration sensor and various operations are carried out depending upon vibration applied to the information processing apparatus proper.

Assume that the interval of a specific operation (double touch) using a touch panel is short. When operation of the touch panel is detected in such case, there will be instances where detection cannot be performed twice because the detection sampling interval is too long. Further, if the touch panel is touched before the panel detection signal returns to the untouched state, a situation in which the touch operation can only be detected one time may arise, a double touch of the touch panel may be discriminated as a single touch and the user may not be able to perform the desired operation. Similarly, if the touching force of the first or second touch of a double-touch operation is weak, then a double touch of the touch panel may be discriminated as a single touch and the user may not be able to perform the desired operation.

Further, with the technique described in Japanese Patent Laid-Open No. 2002-323955, there is the danger that, as the result of a change in writing (finger) pressure while a single-touch operation is in progress, a double touch will be discriminated even though the user intended a single touch. In addition, even in a case where a finger is contacted with the panel and is moved in an effort to perform a drag operation, there is the danger that this will be discriminated as a double touch owing to a change in finger pressure.

### SUMMARY OF THE INVENTION

The present invention has been made in consideration of the aforementioned problems and realizes an operation detection processing technique that enables more reliable detection of a successive-touch operation of a touch panel and of panel operations in addition to this operation, thereby allowing a user to perform desired operations.

In order to solve the aforementioned problems the present invention provides an information processing apparatus comprising: a touch panel; a touch detection unit configured to detect a touch input to the touch panel; a vibration detection unit configured to detect vibration of the information processing apparatus; and a control unit configured to execute a first function in a case where, within a predetermined period of time following detection by the touch detection unit of a single-touch operation in which the touch panel is touched and then released, touch is not detected again by the touch detection unit and, vibration that satisfies predetermined conditions is not detected by the vibration detection unit, and execute a second function when vibration that satisfies the predetermined conditions is detected by the vibration detection unit within the predetermined period of time following detection of the single-touch operation by the touch detection unit.

In order to solve the aforementioned problems the present invention provides a control method of an information processing apparatus which has a touch panel, a touch detection unit configured to detect a touch input to the touch panel and a vibration detection unit configured to detect vibration of the information processing apparatus, the method comprising a control step of: executing a first function in a case where, within a predetermined period of time following detection by the touch detection unit of a single-touch operation in which the touch panel is touched and then released, touch is not detected again by the touch detection unit and, vibration that satisfies predetermined conditions is not detected by the vibration detection unit; and executing a second function when vibration that satisfies the predetermined conditions is detected by the vibration detection unit within the predetermined period of time following detection of the single-touch operation by the touch detection unit.

According to the present invention, it is possible to detect, with greater reliability, a successive-touch operation of a touch panel and of panel operations in addition to this operation.

Further features of the present invention will become apparent from the following description of exemplary embodiments (with reference to the attached drawings).

### BRIEF DESCRIPTION OF THE DRAWINGS

FIG. 1A is diagram illustrating the general construction of an information processing apparatus according to a first embodiment of the present invention;

FIG. 1B is a functional block diagram illustrating the information processing apparatus according to the first embodiment of the present invention;

FIG. 2A is a flowchart illustrating processing for detecting a double-touch operation according to the first embodiment; and

FIG. 2B is a diagram illustrating criteria used in processing for detecting a double-touch operation according to the first embodiment.

### DESCRIPTION OF THE EMBODIMENTS

Embodiments of the present invention will be described in detail below. The following embodiments are merely examples for practicing the present invention. The embodiments should be properly modified or changed depending on various conditions and the structure of an apparatus to which the present invention is applied. The present invention should not be limited to the following embodiments. Also, parts of the embodiments described below may be appropriately combined.

### First Embodiment

An information processing apparatus according to a first embodiment of the present invention will now be described.

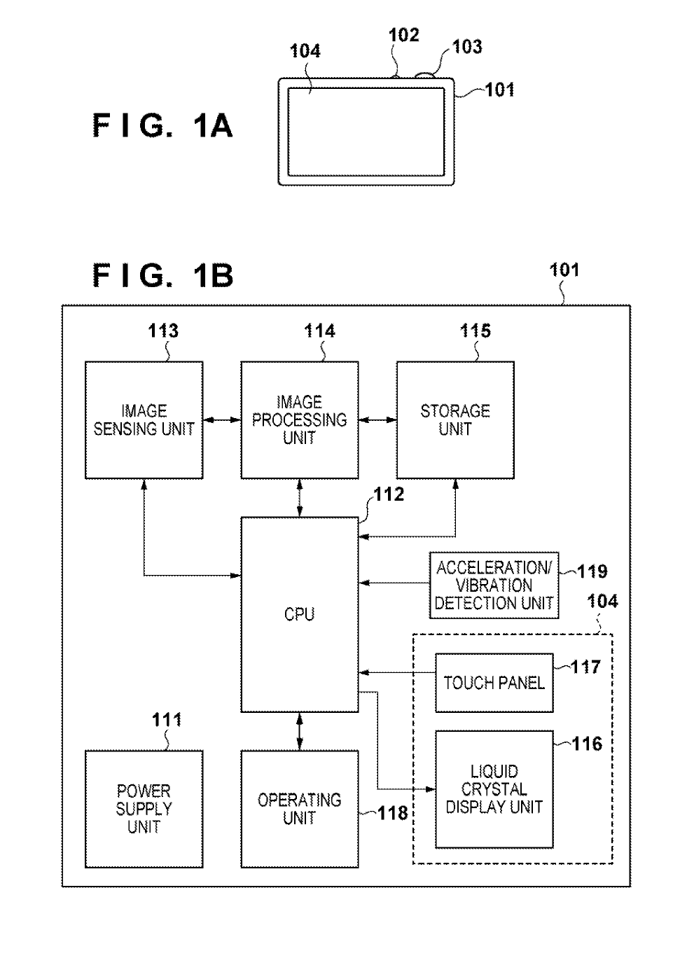

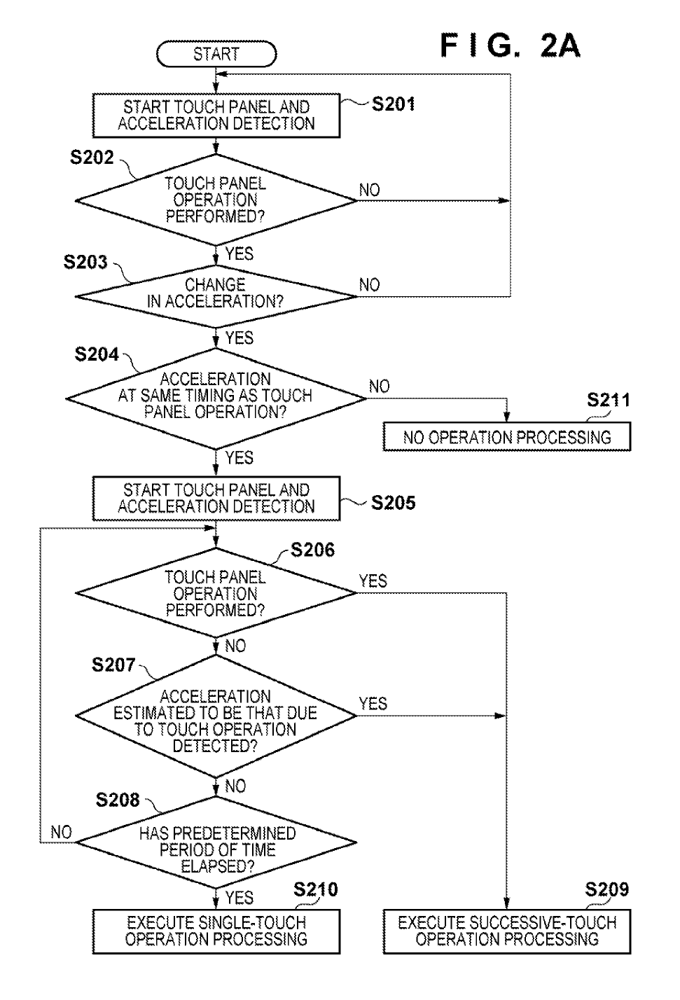

FIG. 1A illustrates the general construction of a digital camera serving as a first embodiment to which the information processing apparatus according to the present invention is applied. Shown in FIG. 1A are a digital camera (camera body) 101, a power switch 102 for introducing power to the camera, and a release switch 103. A liquid crystal panel 104 is equipped with a touch panel for displaying captured and reproduced images, information such as shutter speed, f-stop and number of shots, and for performing key operations.

FIG. 1B illustrates the control block configuration of the above-described digital camera. A power supply unit 111 supplies the camera body 101 with voltage for operating the digital camera. A CPU 112 is for controlling the overall digital camera. An image sensing unit 113 includes a CCD for opto-electronically converting the image of a subject and for generating an image signal. An image processing unit 114 subjects a captured image signal to various signal processing and generates image data. A storage unit 115 stores image data. A liquid crystal display unit 116 displays a captured image and notifies the user of the status of the camera 101. A touch panel 117 is provided. An operating unit 118 comprises various operating members. An acceleration/vibration detection unit (referred to as an “acceleration detection unit” below) 119 comprises components such as an acceleration sensor for detecting acceleration applied to it when the camera body 101 is vibrated. The acceleration detection unit 119 is a three-axis acceleration sensor, by way of example. When the camera body 101 is subjected to vibration, the acceleration detection unit 119 is capable of detecting the acceleration along three axes, namely along the vertical, horizontal and depth directions of the camera body 101, and of outputting acceleration data to the CPU 112.

Although not illustrated in FIG. 1B, various circuits necessary for the digital camera of this embodiment to shoot and to reproduce images are also connected to the CPU 112. The CPU 112 reads out a prescribed program that has been stored in a ROM (not shown) and executes the program. The CPU 112 is capable of detecting the following operations relating to the touch panel 117:

that the touch panel 117 has been contacted with a finger or pen (referred to as “touch-down” below);
that the touch panel 117 is being contacted with a finger or pen (referred to as “touch on” below);
that a finger or pen is being moved while contacting the touch panel 117 (referred to as “move” below);
that a finger or pen that has been in contact with the touch panel 117 has been lifted (referred to as “touch-up” below); and
that the touch panel 117 is not being contacted at all (referred to as “touch-off” below.

These operations and positional coordinates indicating where the touch panel 117 is being touched are reported to the CPU 112 through an internal bus, and the CPU 112 determines, based upon the information of which it has been notified, the kind of operation to which the touch panel 117 has been subjected (e.g., by detecting a double-touch operation, as described later). With regard also to the direction of movement of a finger or pen on the touch panel 117 in the case of the move operation, the CPU 112 can make the determination for every horizontal and vertical component of movement on the touch panel 117 based upon a change in the positional coordinates. Further, when the touch panel 117 undergoes touch-up following touch-down and then a given move operation, the CPU 112 construes that the touch panel 117 has been stroked. A rapid stroke is referred to as a “flick”. A flick is an operation in which a finger is moved rapidly some distance on the touch panel 117 while in contact with the panel and is then lifted from the panel. In other words, a flick is an operation in which the surface of the touch panel 117 is rapidly swept as if it is being flipped by the finger. When movement at a speed equal to or greater than a predetermined speed over a distance equal to or greater than a predetermined distance is detected and then touch-up is detected, it can be determined that a flick has been performed. Further, if movement at a speed lower than the predetermined speed over a distance equal to or greater than the predetermined distance is detected and then touch-up is detected, the CPU 112 determines that a drag operation has been performed. The touch panel 117 may use any of various touch panel systems such as those that rely upon a resistive film, electrostatic capacitance, surface elastic waves, infrared radiation, electromagnetic induction, image recognition and optical sensors.

Double-Touch Operation Detection Processing>

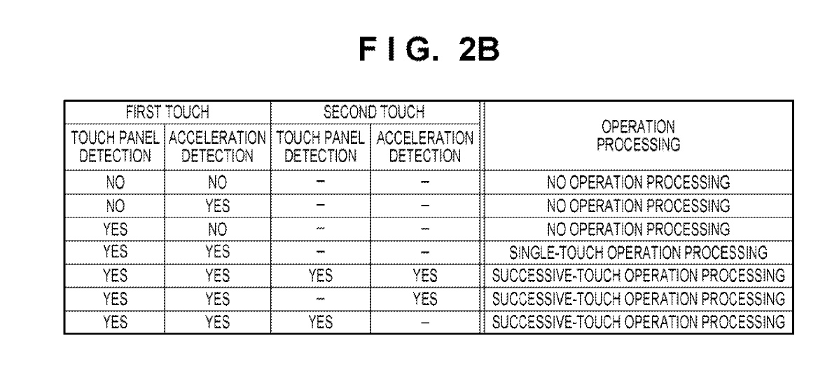

Next, reference will be had to FIGS. 2A and 2B to describe processing for detecting a double-touch operation according to the first embodiment. It should be noted that this processing is implemented by having the CPU 112 read out a program from a ROM and then execute the program.

At step S201 in the flowchart of FIG. 2A, the CPU 112 starts detecting whether a user has subjected the touch panel 117 to a touch input operation and starts detecting a change in acceleration with regard to the camera body 101 by using the acceleration detection unit 119. At step S202, the CPU 112 determines whether the touch panel 117 has undergone a touch operation (whether a touch-and-lift operation, namely touch-up following touch-on, has been detected). If there is no touch input to the touch panel 117, control returns to step S201 and the present state continues. If it is determined at step S202 that here has been a touch input to the touch panel 117, then control proceeds to step S203 and the CPU 112 determines whether there has been a change in acceleration with regard to the camera body 101 based upon the result of detection by the acceleration detection unit 119. If the CPU 112 is to render a “YES” decision in a case where acceleration equal to or greater than a predetermined magnitude (i.e., amplitude) is merely detected, then this can be achieved through a simple arrangement. By having the CPU 112 render a “YES” decision only in a case where predetermined conditions, which include not only magnitude of acceleration but also whether the acceleration waveform (amplitude and wavelength) indicate that they are ascribable to a touch operation, are satisfied, accuracy can be improved and the possibility that a function based upon a touch input will be executed inadvertently can be diminished. For example, one approach that can be considered is to determine the direction of an applied force based upon the waveform in the acceleration data along each axis and to not render the “YES” decision except in a case where it can be determined that a force has been applied to the display surface of the touch panel 117.

If the result of the determination at step S203 is that there has been no change in acceleration applied to the camera body 101, control returns to step S201 and the present state continues. On the other hand, if there has been a change in acceleration applied to the camera body 101, then control proceeds to step S204. Here the CPU 112 determines whether the timing at which the CPU 112 was operated is the same as the timing of the change in acceleration applied to the camera body 101.

If the result of the determination made at step S204 is that the timing at which the CPU 112 was operated is not the same as the timing of the change in acceleration applied to the camera body 101, then control proceeds to step S211. Here the CPU 112 invalidates the touch input operation applied to the touch panel 117 and does not perform any action. On the other hand, if the timing at which the CPU 112 was operated is the same as the timing of the change in acceleration applied to the camera body 101, then control proceeds to step S205. Here the CPU 112 starts detecting whether the user has subjected the touch panel 117 to a touch input operation again within a predetermined period of time following the first touch operation determined at step S204, and starts detecting a change in acceleration with regard to the camera body 101.

At step S206, the CPU 112 determines, based upon the output from the touch panel 117, whether the touch panel 117 has been subjected to a touch operation. This determination too is a determination as to whether a touch-and-lift operation, namely touch-up, has been detected. If touch-up is determined, control proceeds to step S209 and the CPU 112 executes a second function that has been assigned to the double-touch operation. If touch-up is not detected, then control proceeds to step S207.

At step S207, the CPU 112 determines, based upon the acceleration data acquired from the acceleration detection unit 119, whether acceleration estimated to be that ascribable to touching of the touch panel 117 has been detected. Acceleration that satisfies at least the conditions set forth below is considered as acceleration estimated to be that ascribable to touching of the touch panel 117. Any one or a combination of the conditions set forth below may be employed.

(1) Acceleration equal to or greater than a predetermined magnitude (acceleration data indicative of amplitude equal to or greater than a predetermined amplitude). This is implementable through a simple arrangement even in a case where the acceleration detection unit 119 cannot detect acceleration along each of a plurality of axes. This makes it possible to exclude very small acceleration deemed not to be the result of a touch operation.

(2) Acceleration similar to that detected at step S203. That is, this is acceleration for which a value, which indicates the characteristics of the acceleration data such as acceleration amplitude or wavelength detected at step S203, is equal to or greater than a predetermined threshold value. In this case, the acceleration detected at step S203 has been determined at step S204 as being due to a touch operation. Therefore, if an acceleration similar to that detected at step S203 has been detected, then it can be construed that the same operation has been performed twice, i.e., that the touch operation has been performed two times. In this case, accuracy is raised to the extent that it is possible to exclude acceleration that is not due to a touch operation.

(3) Acceleration that matches a predetermined condition that has been stored in a ROM or the like as a condition for discriminating vibration that accompanies a touch operation. The predetermined condition is a threshold value for discriminating the characteristics of the acceleration data such as acceleration amplitude or wavelength stored in the ROM beforehand and obtained by experimental data or the like. It is possible to exclude acceleration or the like caused by a force applied from a direction deemed not to be that of a touch operation applied to the touch panel 117.

(4) A case where, at a timing at which a change in acceleration is detected, the output signal from the touch panel 117 changes, with the value being lower or different from the threshold value at which touch-up is detected at step S206. For example, a resistance value can obtained from the touch panel 117 as the output signal if the touch panel is a resistive-film touch panel or a capacitance value can be obtained from the touch panel 117 as the output signal if the touch panel is an electrostatic-capacitance touch panel. In the case of the double-touch operation, there are instances where, owing to the influence of the first touch, these output signals cannot be obtained as values clearly indicating touch-up as in the manner of the first touch. However, if acceleration also is detected at the same time that a change of some kind has occurred, then it can be construed that a second touch operation has taken place even if the value is not one indicating clear touch-up.

Control proceeds to step S209 if the CPU 112 determines at step S206 that acceleration estimated to be that caused by a touch operation applied to the touch panel 117 has been detected. At step S209, the CPU 112 executes a second function that has been assigned to the double-touch operation. Otherwise, control proceeds to step S208.

At step S208, the CPU 112 determines whether a predetermined period of time has elapsed following the touch-panel operation detected at step S202 or the change in acceleration detected at step S203. The predetermined period of time is a threshold value indicative of whether the interval between a first touch operation and a second touch operation is an interval regarded as that of the double-touch operation. The value can be set to several hundred milliseconds. Control returns to step S206 if the predetermined period of time has not elapsed and proceeds to step S210 if the predetermined period of time has elapsed.

At step S210, the CPU 112 executes a first function that has been assigned to a single touch of the touch panel 117.

At step S209, the CPU 112 executes the second function assigned to double touch. FIG. 2B illustrates a tabulation of the functions (operation processing) executed according to the above-described flowchart and the criteria implemented.

In accordance with this embodiment, as described above, when a specific operation (successive touch) using a touch panel is performed, whether the timings of a detection signal and acceleration detection signal from the touch panel are the same is determined at a first touch-panel operation. It is then determined, based upon whether or not there is a second touch-panel detection signal or second acceleration detection signal, whether a specific operation (successive touch) using the touch panel has been performed. In this way it is possible to reliably detect a specific operation (double touch) that uses a touch panel even in a case where the operation interval is short or the operating force of the first or second touch is weak.

It should be noted that in view of the fact that there is a possibility that touching force will be weaker or touching time shorter in the case of the second touch operation of double touch, it may be arranged so that detection sensitivity is raised by making the detection threshold value of the touch operation at step S205 lower than usual. The elevated detection sensitivity is restored to the original sensitivity at step S209 or S210. However, in accordance with the present invention, detection can be performed accurately by making joint use of detection of acceleration even without adjusting touch detection sensitivity in order to detect the second touch.

Described in this embodiment is an example of double-touch detection processing using the result of touch-panel detection and the result of acceleration detection using an acceleration sensor. However, as long as vibration applied to the body of the apparatus can be detected, the acceleration sensor need not necessarily be used. For example, a camera-shake sensor for detecting shaking of an image capturing apparatus may be used to assist in the detection of vibration regarded as being applied to the image capturing apparatus by touching of the touch panel 117 and in the determination of the type of touch operation.

It should be noted that the above-described double-touch detection processing may be implemented by a single item of hardware. Alternatively, control of the overall apparatus may be performed by having multiple items of hardware share processing.

The foregoing embodiment has been described taking as an example a case where the present invention is applied to a digital camera. However, the present invention is not limited to this example. If the apparatus has a touch panel and is capable of detecting vibration, then the present invention is applicable to the apparatus. Examples of apparatus to which the present invention is applicable include personal computers and PDAs, mobile telephones and mobile image viewers, printers having a display, digital photo frames, music players, game machines and electronic book readers.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-013369, filed Jan. 25, 2011, which is hereby incorporated by reference herein in its entirety.

What is claimed is:

1. An information processing apparatus comprising:
a touch panel;
a touch detection unit configured to detect a touch input to said touch panel;
a vibration detection unit configured to detect vibration of the information processing apparatus; and
a control unit configured to execute a first function in a case where, within a predetermined period of time following detection by said touch detection unit of a single-touch operation in which said touch panel is touched and then released, touch is not detected again by said touch detection unit and, vibration that satisfies predetermined conditions is not detected by said vibration detection unit, and execute a second function when vibration that satisfies the predetermined conditions is detected by said vibration detection unit within the predetermined period of time following detection of the single-touch operation by said touch detection unit.

2. The apparatus according to claim 1, wherein said control unit executes the second function in a case where a second touch operation is detected by said touch detection unit within the predetermined period of time following detection of the single-touch operation by said touch detection unit.

3. The apparatus according to claim 1, wherein in a case where, even though vibration is detected by said vibration detection unit within the predetermined period of time following detection of the single-touch operation by said touch detection unit, the vibration does not satisfy the predetermined conditions, said control unit forgoes execution of the second function in accordance with the vibration.

4. The apparatus according to claim 1, wherein said control unit executes the second function in a case where, following detection of the single-touch operation by said touch detection unit, acceleration generated to the information processing apparatus attendant upon the touch operation is equal to or greater than a predetermined magnitude.

5. The apparatus according to claim 1, wherein said control unit executes the second function in a case where, following detection of the single-touch operation by said touch detection unit, the magnitude of acceleration generated to the information processing apparatus attendant upon the touch operation is equal to or greater than a predetermined threshold value.

6. The apparatus according to claim 1, wherein said control unit executes the second function in a case where, following detection of the single-touch operation by said touch detection unit, the waveform of acceleration generated to the information processing apparatus attendant upon the touch operation satisfies predetermined conditions.

7. The apparatus according to claim 1, wherein said control unit executes the second function in a case where, even if vibration that satisfies the predetermined conditions is not detected following detection of the first touch operation by said touch detection unit, acceleration is generated to the information processing apparatus attendant upon the touch operation and, this acceleration has changed from acceleration that accompanies the first touch operation.

8. The apparatus according to claim 1, wherein the information processing apparatus is an image capturing apparatus having an image sensing unit.

9. A control method of an information processing apparatus which has a touch panel, a touch detection unit configured to detect a touch input to said touch panel and a vibration detection unit configured to detect vibration of the information processing apparatus, the method comprising a control step of:
executing a first function in a case where, within a predetermined period of time following detection by the touch detection unit of a single-touch operation in which the touch panel is touched and then released, touch is not detected again by the touch detection unit and, vibration that satisfies predetermined conditions is not detected by the vibration detection unit; and
executing a second function when vibration that satisfies the predetermined conditions is detected by the vibration detection unit within the predetermined period of time following detection of the single-touch operation by the touch detection unit.

10. A non-transitory computer-readable storage medium storing a program for causing a computer to execute the control method of the information processing apparatus according to claim 9.
